(19) United States
(12) Patent Application Publication
(10) Pub. No.: US 2019/0241134 A1
(43) Pub. Date: Aug. 8, 2019

(54) VEHICLE

(71) Applicant: TOYOTA JIDOSHA KABUSHIKI KAISHA, Toyota-shi (JP)

(72) Inventor: Hiroki KAWAKAMI, Okazaki-shi (JP)

(73) Assignee: TOYOTA JIDOSHA KABUSHIKI KAISHA, Toyota-shi (JP)

(21) Appl. No.: 16/254,945

(22) Filed: Jan. 23, 2019

(30) Foreign Application Priority Data
Feb. 6, 2018 (JP) 2018-019408

(51) Int. Cl. B60R 16/02; H02G 3/30; H02G 3/04

(52) U.S. Cl. CPC B60R 16/0215; B62D 25/025; H02G 3/0456; H02G 3/30

(57) ABSTRACT

A vehicle includes two or more hooks and a flat wire. The two or more hooks are arranged side by side in a predetermined direction of the vehicle. The flat wire is attached to the two or more hooks, and extends in the predetermined direction of the vehicle.

### INCORPORATION BY REFERENCE

The disclosure of Japanese Patent Application No. 2018-019408 filed on Feb. 6, 2018 including the specification, drawings and abstract is incorporated herein by reference in its entirety.

### BACKGROUND

### 1. Technical Field

The present disclosure relates to a vehicle having a structure for routing a flat wire.

### 2. Description of Related Art

As a structure for routing a wire harness 160 in which a plurality of wires is bundled in a vehicle, for example, a vehicle body side portion 100 shown in FIGS. 5 and 6, a structure for routing a flat wires is provided in the vehicle, where a predetermined space between an upper surface portion 122B of a rocker inner panel 122 that is a part of a rocker panel 120, and a scuff plate 150 is provided, and the wire harness 160 runs through the space. In the above-mentioned routing structure, a fixing member 160A (such as a resin clip or the like) is used as a separate part to fix the wire harness 160 to the vehicle.

In recent years, using a belt-shaped flat wire, in place of the wire harness 160, has been suggested. The flat wire is disclosed in, for example, Japanese Unexamined Patent Application Publication No. 2014-116286 (JP 2014-116286 A).

### SUMMARY

In a case of assembling the flat wire to the vehicle, it may be conceivable to use a fixing member as a member separated from the fixing member to fix the flat wire to the vehicle, as in the case of the wire harness. However, when the fixing member is used, a process of aligning the fixing member to a mounting hole provided in the vehicle is needed, which may result in taking time and effort in assembling the flat wire to the vehicle. Furthermore, since the fixing member is an additional part, the cost or weight of the vehicle may be increased.

The present disclosure provides a vehicle having a structure for routing a flat wire capable of allowing the flat wire to be easily assembled to the vehicle without preparing a fixing member so as to fix the flat wire to the vehicle.

An aspect of the disclosure relates to a vehicle. The vehicle includes two or more hooks mounted on the vehicle, and two or more hooks being arranged side by side in a predetermined direction of the vehicle, and a flat wire attached to the two or more hooks, and the flat wire extending in the predetermined direction of the vehicle.

According to the aspect of the disclosure, it is possible to easily assemble the flat wire to extend in the predetermined direction of the vehicle without preparing a fixing member to fix the flat wire to the vehicle.

In the vehicle according to the aspect, the two or more hooks each have a claw having a length equal to or longer than a half of a width in a lateral direction of the wire, and the wire is interposed between a frame member of the vehicle and the claw.

According to the aspect of the disclosure, it is possible to make it difficult for the wire to be disengaged from the two or more hooks.

In the vehicle according to the aspect, the claws that the two or more hooks have may be arranged to extend in the same direction.

According to the aspect of the disclosure, it is possible to easily insert the wire into the two or more hooks from one direction to attach the wire.

In the vehicle according to the aspect, the frame member of the vehicle and the claws may be disposed with a space between the frame member and the claws, and the space has an opening directed to a direction in which the wire does not fall to a lower side of the vehicle by gravity.

In the vehicle according to the aspect, the claws of the two or more hooks may extend in a vertical direction of the vehicle, and the wire may be attached to the two or more hooks such that the lateral direction of the wire is directed to the vertical direction of the vehicle.

In the vehicle according to the aspect, the two or more hooks may be provided outward of a floor panel in a width direction of the vehicle, and the two or more hooks may be provided on a rocker inner panel such that the two or more hooks are arranged side by side in a front-rear direction of the vehicle. According to the aspect of the disclosure, it is possible to route the wire in a small space.

In the vehicle according to the aspect, the wire may be attached to the two or more hooks and extend in the front-rear direction of the vehicle.

According to the aspect described above, it is possible to easily assemble a flat wire to a vehicle without preparing a separate fixing member to fix the flat wire to the vehicle.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a rear perspective view of a vehicle having a routing structure for a flat wire according to an embodiment;

FIG. 2 is a sectional view taken along the line II-II in a vehicle body side portion shown in FIG. 1;

FIG. 3A is a perspective view for describing a method of routing the flat wire in the routing structure according to the embodiment;

FIG. 3B is a perspective view of the vehicle body side portion in a state in which the flat wire is routed in the routing structure according to the embodiment;

FIG. 3C is a sectional view taken along the line IIIC-IIIC in the vehicle body side portion shown in FIG. 3B;

FIG. 4A is a perspective view for describing a method of routing a flat wire in a routing structure according to another embodiment;

FIG. 4B is a perspective view of a vehicle body side portion in a state in which the flat wire is routed in the routing structure according to the other embodiment;

FIG. 5 is a rear perspective view of a vehicle having a routing structure of a wire harness in the related art; and

FIG. 6 is a sectional view taken along the line VI-VI in a vehicle body side portion shown in FIG. 5.

### DETAILED DESCRIPTION OF EMBODIMENTS

Overview

A vehicle according to an embodiment has a routing structure for a flat wire having two or more hooks arranged side by side in a predetermined direction of the vehicle. By attaching the flat wire to the two or more hooks to assemble the flat wire to the vehicle, it is possible to easily assemble the flat wire to extend in the predetermined direction of the vehicle without preparing a separate fixing member to fix the flat wire to the vehicle.

Hereinafter, a vehicle having a routing structure for a flat wire according to the embodiment will be described in detail with reference to drawings. In each drawing, the arrow UP indicates an upper side in a vertical direction of the vehicle, the arrow RE indicates a rear side in a front-rear direction of the vehicle, and the arrow OUT indicates an outer side in a width direction of the vehicle.

Vehicle Structure

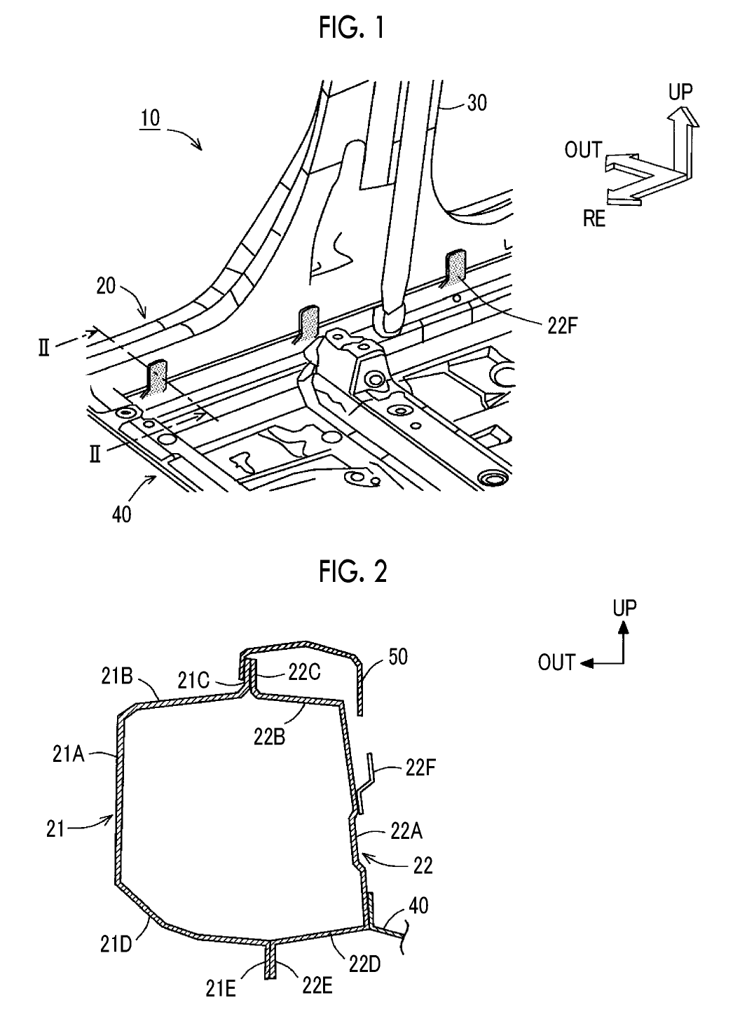

FIG. 1 is a perspective view of a structure of a main part in a vehicle body side portion 10 of a vehicle having a routing structure for a flat wire according to an embodiment, as seen obliquely from the rear right side of the vehicle. FIG. 2 is a sectional view taken along the line II-II at the vehicle body side portion 10 shown in FIG. 1. In the sectional view of FIG. 2, some elements that are not drawn in FIG. 1 are included. In the embodiment, the structure of the left side of the vehicle body side portion 10 will be described, but the same can be applied to the right side of the vehicle body side portion 10.

As shown in FIGS. 1 and 2, a rocker panel 20, which is a member making up the frame of the vehicle body, extends in the front-rear direction of the vehicle at a lower part of the vehicle body side portion 10. The rocker panel 20 is provided on both sides in the width direction of the vehicle in a right-left symmetrical manner (in the specification, “right-left symmetry” includes “substantially right-left symmetry” in its meaning). The lower end portion of a center pillar 30 and an end portion of a floor panel 40 in the width direction of the vehicle are connected to corresponding predetermined positions of the rocker panel 20.

The rocker panel 20 includes a rocker outer panel 21 formed in a hat shape of which crown part projects outward in the width direction of the vehicle and a rocker inner panel 22 formed in a hat shape of which crown part projects inward in the width direction of the vehicle (in the specification, “hat shape” includes “substantially hat shape” in its meaning).

The rocker outer panel 21 has a wall surface portion 21A parallel to the vertical direction of the vehicle, an upper surface portion 21B bent and extended inward in the width direction of the vehicle from the upper end edge of the wall surface portion 21A in the vertical direction of the vehicle, an upper flange portion 21C bent and extended upward in the vertical direction of the vehicle from the inner edge of the upper surface portion 21B in the width direction of the vehicle, a lower surface portion 21D bent and extended inward in the width direction of the vehicle from the lower end edge of the wall surface portion 21A in the vertical direction of the vehicle, and a lower flange portion 21E bent and extended downward in the vertical direction of the vehicle from the inner edge of the lower surface portion 21D in the width direction of the vehicle (in the specification, “parallel” includes “substantially parallel” in its meaning).

The rocker inner panel 22 has a wall surface portion 22A parallel to the vertical direction of the vehicle, an upper surface portion 22B bent and extended outward in the width direction of the vehicle from the upper end edge of the wall surface portion 22A in the vertical direction of the vehicle, an upper flange portion 22C bent and extended upward in the vertical direction of the vehicle from the outer edge of the upper surface portion 22B in the width direction of the vehicle, a lower surface portion 22D bent and extended outward in the width direction of the vehicle from the lower end edge of the wall surface portion 22A in the vertical direction of the vehicle, a lower flange portion 22E bent and extended downward in the vertical direction of the vehicle from the outer edge of the lower surface portion 22D in the width direction of the vehicle, and a hook 22F provided inward from the wall surface portion 22A in the width direction of the vehicle.

The rocker panel 20 has a configuration in which the upper flange portion 21C of the rocker outer panel 21 and the upper flange portion 22C of the rocker inner panel 22 are joined to each other by spot welding or the like, and the lower flange portion 21E of the rocker outer panel 21 and the lower flange portion 22E of the rocker inner panel 22 are joined to each other by spot welding or the like, which results in the formation of a hollow rectangular closed sectional structure (in the specification, “rectangular” includes “substantially rectangular” in its meaning).

A scuff plate 50 is provided above the upper surface portion 22B of the rocker inner panel 22 in the vertical direction of the vehicle. The floor panel 40 is joined to the wall surface portion 22A of the rocker inner panel 22 by spot welding or the like.

The hook 22F of the rocker inner panel 22 is a member having a claw for attaching and fixing a belt-shaped flat wire 60 which will be described later. The hook 22F may be formed, for example, by joining a separate part (bracket or the like) serving as the claw to the wall surface portion 22A by welding or the like, or by cutting and raising the claw from the wall surface portion 22A. The hook 22F is not particularly limited, but two or more hooks 22F may be provided depending on the shape, the length in the longitudinal direction, the width in the lateral direction, the thickness, and the routing direction of the flat wire 60. Furthermore, the hook 22F may be desirably provided such that the claw is extended in the same direction. The rocker panel 20 and the claws are disposed with a space between the rocker panel 20 and the claw, and an opening direction of the space may be a direction in which the flat wire 60 does not fall to a lower side of the vehicle by gravity. Furthermore, the hook 22F may not be provided outward of the floor panel 40 in the width direction of the vehicle, and may not be provided on the rocker inner panel 22 so as to align with another hook side by side in the front-rear direction of the vehicle, as shown in FIG. 2. The example of FIG. 1 shows a structure in which three hooks 22F extending to the upper side of the vehicle are provided in the front-rear direction of the vehicle so as to route the flat wire 60 to the front or rear of the vehicle.

The flat wire 60 is a belt-shaped flat plate member made up of a conductive metal material such as iron, copper, and aluminum. The flat wire 60 may be used as an electrical wire for supply power for a load such as an electronic control unit (ECU) (not shown) mounted on the vehicle, for example. Part of the flat wire 60 other than connection terminals, which is not needed to be electrically connected, is covered with, for example, an insulating film or the like, to be electrically insulated.

Routing Structure of Flat Wire

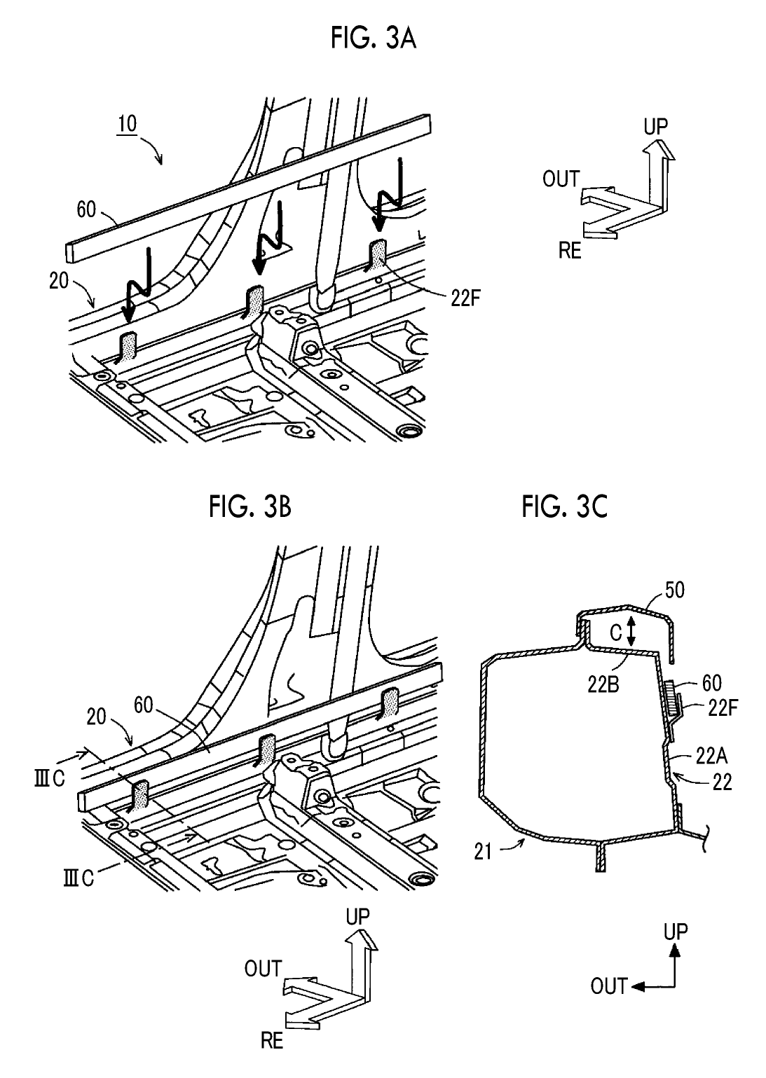

Next, with reference to FIGS. 3A to 3C, a method of routing the flat wire 60 in the vehicle having the routing structure described above will be described. FIG. 3A is a perspective view for describing a method of attaching the flat wire 60 to the hook 22F provided at the wall surface portion 22A of the rocker inner panel 22 of the vehicle body side portion 10 shown in FIG. 1, FIG. 3B is a perspective view of the vehicle body side portion 10 in a state in which the flat wire 60 is attached to the hook 22F, and FIG. 3C is a sectional view taken along the line IIIC-IIIC in the vehicle body side portion 10 shown in FIG. 3B.

As shown in FIG. 3A, a plurality of hooks 22F is extended in the same direction as that of the claws and the hooks are linearly arranged in the front-rear direction of the vehicle, which makes it possible to easily assemble the flat wire 60 in one direction as it is indicated by the arrow, in this case, in a way of running longitudinally in the vehicle (front to back of the vehicle) (FIG. 3B). As shown in FIG. 3C, the assembled flat wire 60 is held in a state of being interposed between the rocker panel 20 (rocker inner panel 22 thereof) that is a frame member of the vehicle and the hook 22F (claw thereof).

With the structure described above, it is unnecessary to use a separate fixing member (resin clip or the like) that is needed in the structure of the related art to fix the flat wire 60 to the vehicle, and it is also unnecessary to take time and effort for alignment to attach the fixing member to the vehicle. In addition, since the flat wire 60 is routed along the wall surface portion 22A of the rocker inner panel 22, a space C between the upper surface portion 22B of the rocker inner panel 22 and the scuff plate 50 in the structure described above can be made relatively small, compared with that in the routing structure of the related art in which a wire harness 160 is routed at the upper surface portion 122B of the rocker inner panel 122 shown in FIG. 6 (FIG. 3C). Furthermore, if the claw of the hook 22F is formed to have a length equal to or longer than a half of a width of a lateral direction of the flat wire 60, the effect can be expected that the flat wire 60 is difficult to be disengaged from the hook 22F.

Other Routing Structure

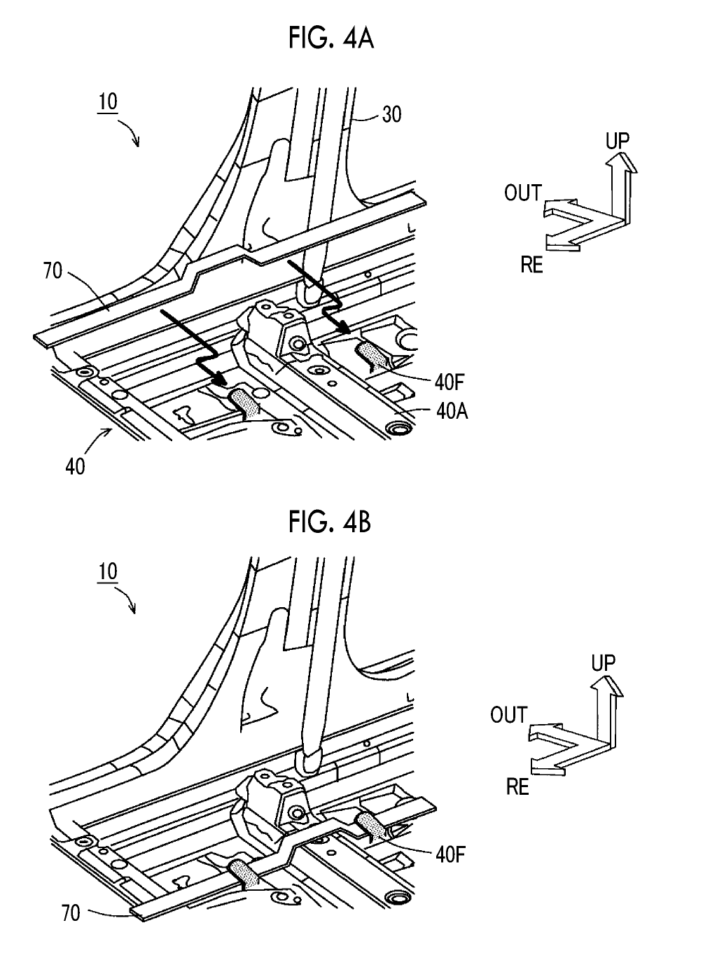

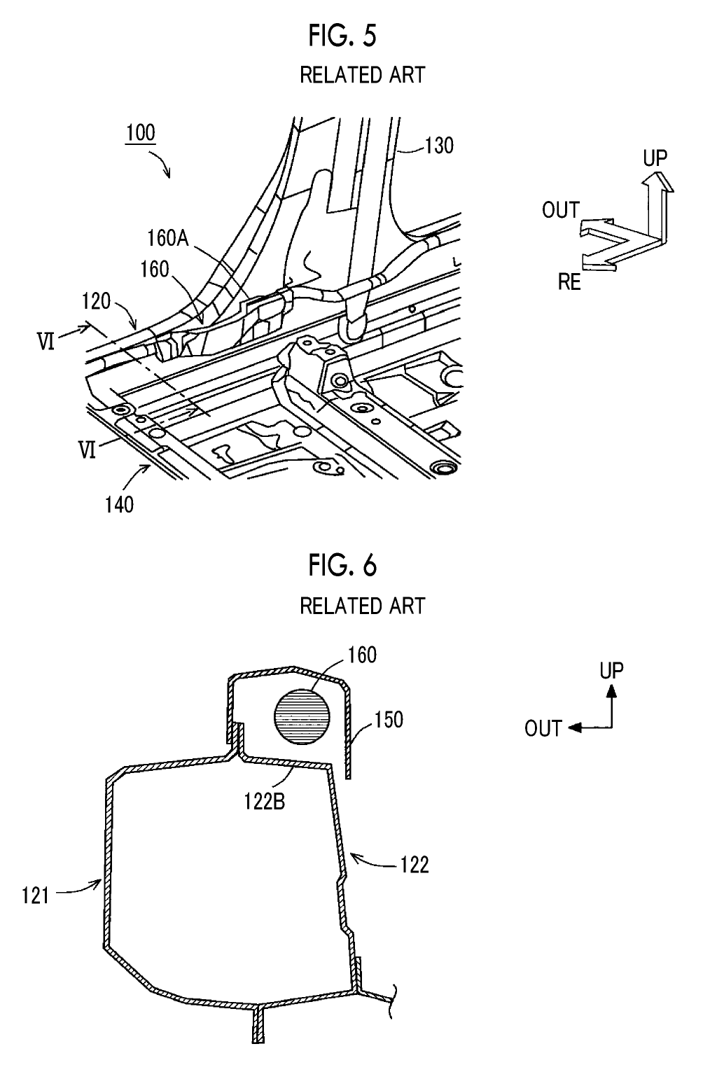

With reference to FIGS. 4A and 4B, a method of routing a flat wire 70 in a vehicle having another routing structure will be described. FIG. 4A is a perspective view for describing a method of attaching a flat wire 70 to a hook 40F provided in a floor panel 40 of a vehicle body side portion 10, and FIG. 4B is a perspective view of the vehicle body side portion 10 in a state in which the flat wire 70 is attached to the hook 40F.

As shown in FIG. 4A, in a case where the flat wire 70, which has a shape straddling a floor cross member 40A, is routed on a floor panel 40, a plurality of hooks 40F is provided at the floor panel 40, which makes it possible to easily assemble the flat wire 70 in one direction as it is indicated by the arrow, in this case, in a way of running longitudinally in the vehicle (FIG. 4B). The flat wire 70 is a flat plate member having some part that is insulation-covered as the flat wire 60 described above. The shape of the hook 40F may be the same as that of the hook 22F described above.

Operation and Effect of Embodiments

As described above, with the vehicle having the routing structure for the flat wires 60, 70 according to the embodiments, two or more hooks 22F, 40F arranged side by side in a predetermined direction of the vehicle, for example, in the front-rear direction of the vehicle, are provided, and the flat wires 60, 70 are attached to the two or more hooks 22F, 40F and assembled to extend in a predetermined direction of the vehicle, for example, in the front-rear direction of the vehicle.

With the routing structure, it is possible to easily assemble the flat wires 60, 70 to extend in a predetermined direction of the vehicle without preparing separate fixing members to fix the flat wires 60, 70 to the vehicle.

The routing structure of the flat wire according to the embodiments can be used for a vehicle such as an automobile and is useful, for example, when it is desired to easily assemble the flat wire to the vehicle without preparing a separate fixing member to fix the flat wire to the vehicle.

What is claimed is:

1. A vehicle comprising:
two or more hooks mounted on the vehicle, and two or more hooks being arranged side by side in a predetermined direction of the vehicle; and
a flat wire attached to the two or more hooks, and the flat wire extending in the predetermined direction of the vehicle.

2. The vehicle according to claim 1, wherein:
the two or more hooks each have a claw having a length equal to or longer than a half of a width in a lateral direction of the wire; and
the wire is interposed between a frame member of the vehicle and the claw.

3. The vehicle according to claim 2, wherein the claws of the two or more hooks have are arranged to extend in the same direction.

4. The vehicle according to claim 3, wherein:
the frame member of the vehicle and the claws are disposed with a space between the frame member and the claws; and
the space has an opening directed to a direction in which the wire does not fall to a lower side of the vehicle by gravity.

5. The vehicle according to claim 2, wherein:
the claws of the two or more hooks extend in a vertical direction of the vehicle; and
the wire is attached to the two or more hooks such that the lateral direction of the wire is directed to the vertical direction of the vehicle.

6. The vehicle according to claim 1, wherein the two or more hooks are provided outward of a floor panel in a width direction of the vehicle.

7. The vehicle according to claim 6, wherein the two or more hooks are provided on a rocker inner panel such that the two or more hooks are arranged side by side in a front-rear direction of the vehicle.

8. The vehicle according to claim 7, wherein the flat wire is attached to the two or more hooks, and the flat wire extends in the front-rear direction of the vehicle.
